(19) United States
(12) Patent Application Publication
(10) Pub. No.: US 2009/0278818 A1
(43) Pub. Date: Nov. 12, 2009

(54) THUMB WORN TAP DEVICES AND STORAGE HOLDERS FOR USE WITH HANDHELD ELECTRONICS

(76) Inventors: Jon Mario DiNozzi, Middletown, DE (US); Steven Michael DiNozzi, Middletown, DE (US)

Correspondence Address: CONNOLLY BOVE LODGE & HUTZ, LLP, P O BOX 2207, WILMINGTON, DE, 19899, US

(21) Appl. No.: 12/119,277

(22) Filed: May 12, 2008

(51) Int. Cl. G06F 3/033

(52) U.S. Cl. 345/179

(57) ABSTRACT

A tap device for use when selecting icons or keying data into a touch screen hand-held electronic device includes a base and associated sleeve that is worn around the thumb. A conductive nib projects outwardly from an opposite side of the base at an angle to the axis of the user's thumb. A conductive post extends through an opening in the base and links the nib to a conductive seat portion that contacts the user's thumb. When not in use, the tap device may be snap-inserted onto an outwardly directed prong of a storage clip. The storage clip may be fastened over the hand-held electronic device.

### BACKGROUND OF THE INVENTION

1. Field of the Invention

This invention relates to a tap device or stylus that is worn preferably over a user's thumb to assist with interfacing with and inputting data more accurately into a touch screen handheld electronic device, such as an iPhone®, Blackberry®, cellphone, personal desk assistant (PDA), or other computer device.

2. Description of the Prior Art

In 2007, Apple, Inc. introduced the iPhone®, a handheld electronic device with cellular telephone, messaging and internet capabilities. The device has a sleek exterior profile and a capacitive touch screen, such that users interact and enter data solely by contacting the screen with their fingers. For persons with large fingers or long fingernails, the touch screen can be difficult to use. However, known stylus devices without the level of conductivity associated with a human finger cannot be used to activate the capacitive touch screen.

Cellular telephones (cellphones), smart phones, and personal desk assistants (PDAs) comprise other known handheld devices that may variously include capacitive touch screens or a combination of capacitive touch screen and small push button key pads. These electronic devices also challenge users with large fingers or long fingernails when entering data or telephone numbers or making function selections.

Known stylus devices include wand-shaped or pen-shaped rods that frequently have small diameters. These known styli may fit within a slot or channel or opening provided in the casing of the electronic handheld device or in a pouch or pocket of a separate cover for the handheld device. Most often, however, such styli are lost or misplaced. Wand-shaped or pen-shaped styli limit the speed of data entry because they are intended for use with one hand while the other hand is occupied by holding the hand held device. Devices with a touch screen data interface can be operated more quickly with two thumb data entry.

In the background art, certain finger securable styli have been proposed. U.S. Pat. No. 6,626,598 shows an adjustable finger stylus with a curved base that rests against a fingertip and a band that is wrapped around the finger to secure the stylus in place. A stylus tip (tapered writing extension) projects outwardly from the external side of the base in a direction generally parallel to the longitudinal axis of the user's finger.

U.S. Pat. No. 6,587,090 shows a finger securable computer input device that has a stylus nib attached to a stylus side surface tip end. The device has the appearance of a finger splint, and is worn over a finger, such as an index finger.

GB 2 173 597 shows a position sensing touch panel with a pressure operable switch attached to a band of elastic material. This touch panel may be worn around a user's finger to cause a projection to extend outwardly from the user's fingertip.

GB 2 409 277 describes a finger-mounted inductive digitizer input device that has a plastic or rubber casing. A circuit housing is mounted on the casing, and includes a switch at the tip. One of the devices illustrated is a thimble style and may be worn over a finger tip.

US 2003/0214481 A1 shows a finger worn and operated input device. The device is illustrated as worn on a thumb, and it includes a sensor having necessary electronic components to transmit signals, such as radio frequency (RF) to a receiving device, such as a personal computer.

U.S. Pat. No. 7,210,999 shows a game system in which a finger with a conductive covering worn on a fingertip (fingersleeve 126) completes the circuit or circuits exposed at the touch point. The fingersleeve is stated to have a higher level of conductivity than a human finger.

U.S. Design Pat. No. D487,896 shows a fingertip stylus for small keyboard or touch screen data input. The stylus is a sleeve with a projecting nib formed integrally and would appear to extend in a direction outwardly from a fingertip when the sleeve is worn.

Hence, there remains a need for a stylus or tap device that can be used with various electronic handheld devices, such as capacitive touch screen handheld devices, that overcomes the drawbacks of known styli.

### SUMMARY OF INVENTION

A tap device for use with a touch screen handheld electronic device has a base with a first surface and an opposite surface. The first surface may be curved to accommodate the contour of a user's thumb print. The base defines at least one opening therethrough. A nib having at least a conductive tip portion is joined to the base by a post that has a distal end in electrically communicative contact with the conductive tip portion of the nib, and a proximal end in contact with a seat portion. In one embodiment, the post is threadably connected to the nib. The post extends through the opening in the base and the seat portion contacts the first surface of the base. A sleeve operably connects to the base so that when a user's thumb is inserted into the sleeve the sleeve holds such thumb in contact with the base or an overlay or friction pad placed over the base, with the first surface of the base facing the user's thumb and the opposite surface of the base being directed away from the user's thumb. At least a portion of the user's thumb is held in contact with at least a part of the seat portion. The nib projects outwardly and away from the opposite surface of the base.

The base may be formed from a substantially rigid material that is sufficiently rigid to permit touch screen operation without undue bending of the base, the collar or the nib. Substantially rigid materials that may be suitable for the base include thermosetting plastics and other polymers and synthetic polymers, such as ethylene methyl acrylate (EMA) copolymers, ethylene vinyl acetate (EVA) copolymers, acrylics, high density polyethylenes (HDPE), styrenics (IMPS), acrylonitrile-butadiene-styrene (ABS) copolymers, poly(methylmethacrylates) (IM-PMMA), alpha-polyolefins, polypropylene, polycarbonate, polycaprolactam, polycaprolactone, polyacrylates, polyurethanes, polyesters, and mixtures thereof. Preferably, if the base material is sufficiently electrically conductive, the collar and nib are formed as part of the mold of the base from the same substantially rigid material as the base.

The sleeve may be formed from a fabric or a rubber or other material with stretch or resiliency to provide a comfortable fit around a user's thumb, and to accommodate users with varying thumb widths. Stretchy or resilient materials that may be suitable for the sleeve include: stretch fabrics, such as fabrics comprised of or incorporating elastomeric fibers or elastomeric yarns including spandex, or rubbers, fleece, Velcro® fastener tapes and polyurethane foams. Dri-FIT® fabric from Nike, Inc. comprising a polyester microfiber blend with spandex is one preferred stretch fabric to form the sleeve. Other preferred stretch fabrics are HeatGear®, ColdGear®, AllSeasonGear®, and other stretch fabrics made by Under Armour. The sleeve may be operably connected to the base with one or more adhesives. The sleeve may include a portion of fabric with no stretch or minimal stretch that with the stretchy or resilient material together forms a tube shape and facilitates joining the sleeve to the base.

In one embodiment, the tap device further includes an overlay or friction pad placed in contact with the first surface of the base. In such an embodiment, preferably the overlay or friction pad defines an opening through which at least a portion of the seat portion associated with the post is exposed.

As another alternative, a second friction pad is adhered to the second surface of the base. The second friction pad extends from the rear of the tab device and stops short of the collar. The second friction pad also defines a centered hole or indentation near the rear of the friction pad through which a female type button may be exposed or into which female type mating connector may be integrated. The female type button or female type mating connector connects with a snap or a projection or a prong or male button of a holder to which the thumb worn tap device may be secured for storage when not in use.

In another embodiment, the opposite surface of the base of the tap device defines a second opening therethrough, or an indentation therein (which could hold a female button connector), that forms a mating connection with a snap or a projection or prong or male button of a holder to which the tap device may be secured for storage.

Either the entire nib or at least the conductive tip portion of the nib is formed from a conductive material so that when the nib contacts a capacitive touch screen the necessary grounding connection is formed to operate such screen. Conductive materials that may be suitable for the nib and tip portion of the nib include: metals, such as copper and its alloys or steel and its alloys, conductive synthetic polymers or conductive composites, such as plastics with embedded metal wires or plastics embedded with electrically conductive particles, such as carbon black or graphite, or with conductive compounds, such as quarternary ammonium salts or with conductive nanoparticles. The post and seat are formed with conductive material such that the necessary grounding connection extends between the user's thumb in contact with the seat portion to the nib and to the capacitive touch screen on the handheld electronic device. Optimally, the post and seat are formed with the same conductive material as the nib. An optional conductive tip portion of a different material could be adhered to the nib to enhance electrical communication between the conductive tip portion and a capacitive touch screen of a handheld electrical device.

The nib defines a central axis and the central axis is directed at an angle outward from the opposite surface of the base. In one exemplary embodiment, the nib extends outwardly at an angle β (beta) in the range of about 30 degrees to about 150 degrees from a longitudinal axis defined by a user's thumb when the tap device is worn on said thumb. In another exemplary embodiment, the nib extends outwardly at an angle β (beta) of about 45 to 60 degrees from the longitudinal axis defined by a user's thumb when the tap device is worn on said thumb. It is also possible to characterize the direction in which the nib projects from the base with reference to a dominant plane of the opposite surface of the base. When so characterized, the central axis of the nib is directed at an angle α (alpha) in the range of about 30 degrees to about 150 degrees, preferably about 90 degrees, from a dominant plane of the opposite surface of the base.

In a still further embodiment of the invention, the thumb worn tap device may be removably attached to a storage clip when not in use. The storage clip may be designed to accommodate one or two or more tap devices. Such storage clip has a first vertical wall separated from a second vertical wall by a bridging portion, wherein the first vertical wall, second vertical wall and bridging portion together form an inverted J-configuration or closed triangle when viewed in side elevation. Optionally, the bridging portion may be curved to increase clamping force of the second vertical wall towards the first vertical wall. At least one prong or projection or male button projects outwardly from an outer surface of the first vertical wall. This at least one prong or projection or male button mates with a receiving hole formed in the base of the tap device or with an indentation or with a female mating connector integrated into or adhered to the second surface of the base of the tap device. In another embodiment, the storage clip includes a second prong or projection or male button projecting outwardly from the outer surface of the first vertical wall, wherein said second prong or projection or male button mates with a receiving hole or indentation formed in a base or a female mating connector integrated into or adhered to the second surface of the base of an additional tap device. The storage clip and at least one prong or projection or male button may be formed from a substantially rigid material, such as a thermosetting plastic or metal.

A first friction pad may be disposed on an inner surface of the first vertical wall. A second friction pad may be disposed on an inner surface of the second vertical wall. The friction pads may be formed of rubber, foamed rubber, latex foam or polyurethane foam, or silicone or polysiloxane, or other suitable dampening material to help secure the slip over a handheld electronic device or over another substrate onto which the user inserts the storage clip. Preferably, the friction pads of the storage clip are made of the same material used to form the overlay or friction pads for the tap device.

### BRIEF DESCRIPTION OF THE DRAWINGS

FIG. 1 is a perspective view of a right hand with a tap device according to one embodiment of the invention worn over the thumb;

FIG. 2 is an assembly diagram in perspective view showing a column, a nib, and a post with threaded distal end attached to a seat at its proximal end;

FIG. 3 is an assembly diagram in perspective view showing the column, nib and post engaged to a base, an overlay pad to be placed over the first surface of the base, and a first embodiment of a sleeve to be joined or connected to the base;

FIG. 4 is a perspective view of a second embodiment of a sleeve that forms a tube shape;

FIG. 5 is an assembly diagram in perspective view showing the column, nib and post engaged to a base, an overlay pad to be placed over the first surface of the base, and a third embodiment of a sleeve to be joined or connected to the base;

FIG. 6 a perspective view of a storage clip according to the invention to which two tap devices have been engaged;

FIG. 7 is a rear perspective view of the storage clip of FIG. 6;

FIG. 8 is a front perspective view of the storage clip of FIG. 6;

FIG. 9 is a rear perspective view of the storage clip of FIG. 6 shown attached to an iPhone® hand held electronic device.

FIG. 10 is a rear perspective view of an alternate storage clip having raised shelf sections according to the invention;

FIG. 11 is a side elevation perspective view of the alternate storage clip of FIG. 10;

FIG. 12 is a front perspective view of the tap device according to one embodiment of the invention;

FIG. 13 is a right side elevational view of the tap device of FIG. 12, wherein the left side elevational view is a mirror image thereof;

FIG. 14 is a front elevational view of the tap device of FIG. 12;

FIG. 15 is a rear elevational view of the tap device of FIG. 12;

FIG. 16 is a top plan view of the tap device of FIG. 12; and

FIG. 17 is a bottom plan view of the tap device of FIG. 12.

### DETAILED DESCRIPTION OF THE PREFERRED EMBODIMENTS

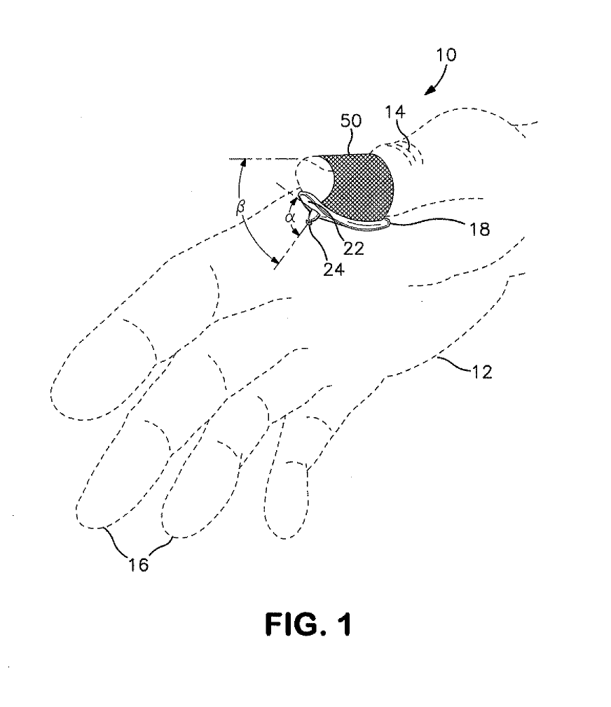

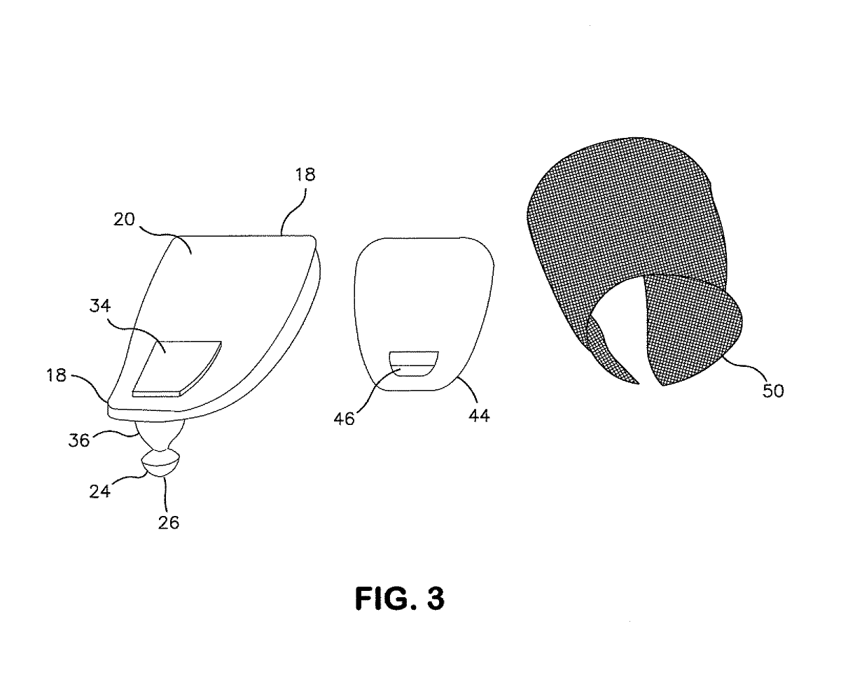

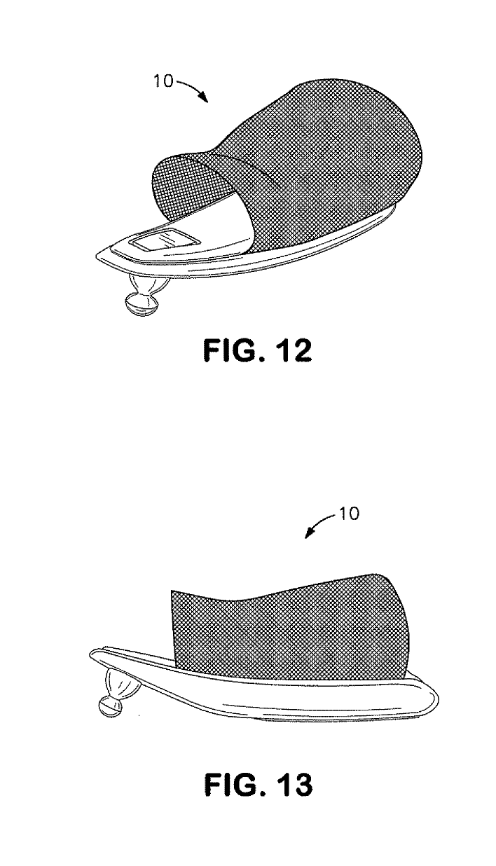

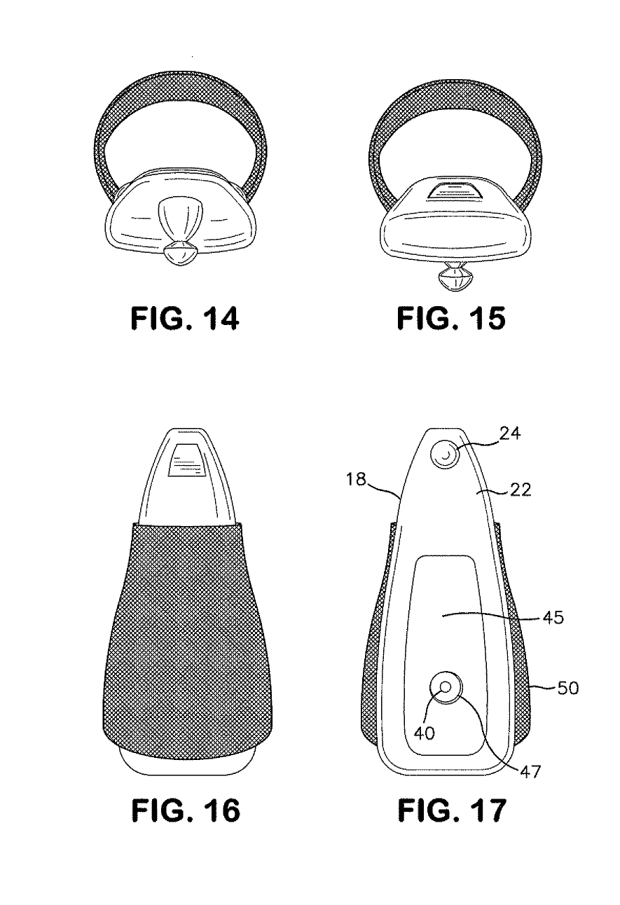

Referring first to FIG. 1, a tap device 10 is shown worn on a user's right hand 12 over the user's thumb 14. The hand 12, thumb 14 and other fingers 16, are shown in phantom outline in FIG. 1. More detailed views of the tap device 10 are shown in FIGS. 12-17. In FIG. 1, the tap device 10 is held in close connection over the thumb 14 because the fabric sleeve 50 holds the thumb contact surface or first surface 20 (see FIG. 3) of the base 18 in contact with the user's thumb 14. In addition, a nib 24 projects outwardly from the opposite surface 22 of the base 18.

The outward projection of the nib 24 may be characterized as being substantially perpendicular from the opposite surface 22 of the base 18. Alternatively, referring to FIG. 1, the outward projection of the nib 24 is characterized as at an angle α (alpha) from the axis of the dominant plane of the opposite surface 22 of the base 18. The angle α (alpha) can be in the range of from about 30 degrees to about 150 degrees, preferably about 90 degrees. As yet another alternative, referring to FIG. 1, the outward projection of the nib 24 is characterized as at an angle β (beta) from the longitudinal axis of a user's thumb or finger when the tap device 10 is worn by said user. The angle β (beta) can be in the range of about 30 degrees to about 150 degrees, preferably about 45 to 80 degrees, most preferably about 45 to 60 degrees.

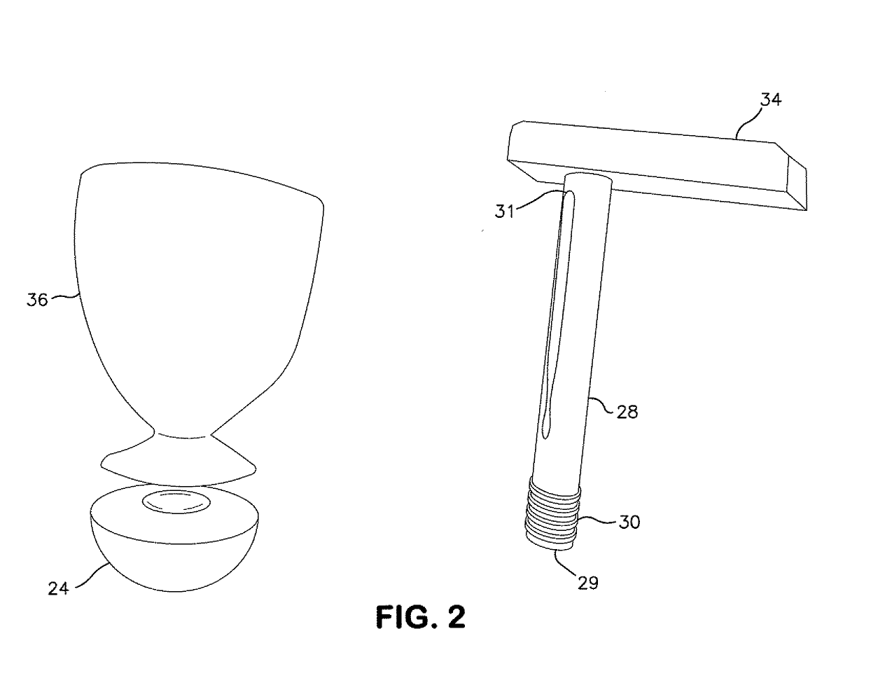

FIG. 2 shows the components forming the tap device or tip and nib. The conductive nib 24 is threadably connected to the distal end 29 of a post 28. At its distal end 29, the post 28 has a series of screw threads 30 that connect to mating threads formed within the core opening of the nib 24. At its proximal end 31, the post 28 contacts a seat portion 34, shown in FIG. 2 as a generally flat panel. The seat portion 34 alternatively may have curved or chamfered edges and may have a concavely shaped upper surface. Optionally, the conductive nib 24 may include a conductive tip 26 (see FIG. 3).

The post 28, nib 24 and seat portion 34 are formed of a conductive material. Conductive materials that may be suitable for the post 28, nib 24 and seat portion 34 include: metals, such as copper and its alloys or steel and its alloys, conductive composites, such as plastics with embedded metal wires or plastics embedded with conductive particles, such as carbon black or conductive nanoparticles, or with conductive compounds such as quarternary ammonium salts, and synthetic polymers that may be made conductive. The post 28, nib 24 and seat portion 34 should be of sufficiently rigid material to avoid undue bending when subjected to varying compressive forces along the lengthwise axis of the post 28. Optionally, the tip 26 of nib 24 may be formed of a different material, which can include the conductive rigid materials as stated, or can include a fabric or nonwoven or other material less apt to scratch a capacitive touch screen when in contact with such screen.

A collar or post cover 36 may be formed as a separate element that is joined to the base 18, or may be integrally formed as an extension from the opposite surface 22 of the base 18. In FIG. 2, the collar 36 is a separate element. The collar 36 defines a central opening (not shown in FIG. 2), through which the post 28 may be inserted before nib 24 is fastened to the distal end 29 of the post 28. While FIGS. 1 and 2 illustrates a tap device having a nib 24 axially aligned at the end of a straight collar or post cover 36, the collar alternatively could have a bent or curved configuration. The collar 36 may have a curved top peripheral edge to facilitate attachment to the opposite surface 22 of the base 18.

Referring next to FIG. 3, the post 28 is further inserted through an opening or hole extending through the base 18. When so inserted, seat portion 34 contacts the first surface 20 or thumb contacting surface of the base 18. The thumb contacting surface 20 is shown as concavely curved to comfortably accommodate a user's thumb when in contact with the thumb-print portion opposite the thumbnail (see also FIG. 13). As such the user's thumb can be in contact with the upper surface of the seat portion 34.

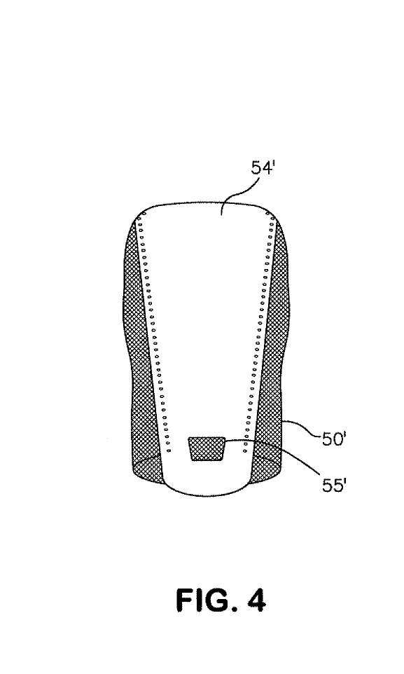

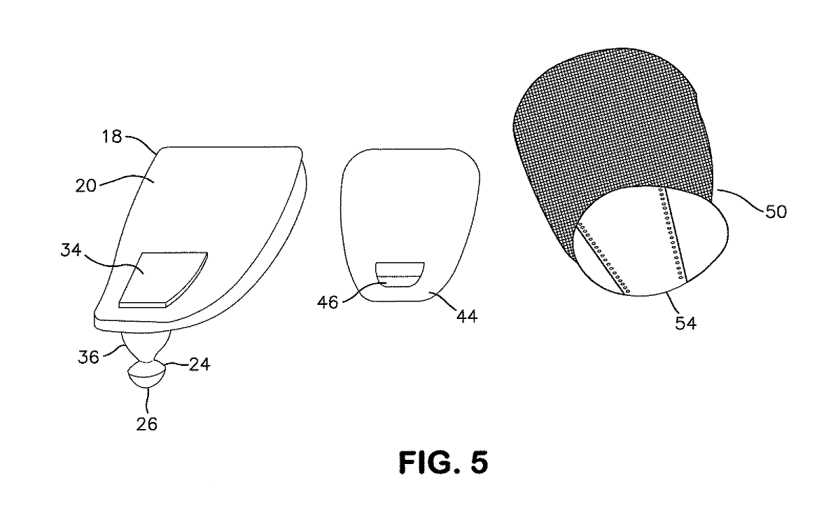

In two other exemplary embodiments, the sleeve 50, 50′ is formed as a tubular structure as shown in FIGS. 4 and 5, with a sleeve portion 50, 50′ of a stretchy or resilient material and a panel 54 or 54′ of other substantially non-stretch material sewn or adhered to the edges of the sleeve portion. Such panel 54 or 54′ better facilitates joining the sleeve 50, 50′ to the first surface 20 of the base 18 because the panel 54 or 54′ may be adhered to the first surface 20 with one or more adhesives. After the sleeve has been adhered to the first surface 20 with one or more adhesives, an overlay pad or friction pad 44 may be so joined with one or more adhesives onto the already adhered non-stretch panel 54 or 54′ and any remaining exposed area of first surface 20 that is near and around the seat portion 34. Where panel 54′ with a longer length is installed, there may not be any remaining exposed area of first surface 20 and friction pad 44 will contact such panel 54′ only. In FIG. 4, the panel 54′ has a width that tapers to correlate more closely with the shape of the overlay pad 44 or the first surface 20.

Optionally, the sleeve 50 may be an open tube such as shown in FIG. 3, and the side edges of said sleeve 50 may be adhered to the first surface 20 of the base 18.

As shown in FIGS. 3 and 5, the overlay pad or friction pad 44 defines a slot or hole 46 therethrough at the forward portion such that the seat portion 34 is exposed through said slot or hole 46 when the overlay pad or friction pad 44 is engaged or joined to the first surface 20 of the base 18. The sleeve 50, 50′ wraps a user's thumb so as to hold the thumb in contact with the friction pad 44 and seat portion 34 or in contact with the first surface 20 and seat portion 34 when a friction pad 44 is not used.

Optionally, as shown in FIG. 4, panel 54′ may define an opening 55′ therethrough to align with the opening 46 in the friction pad 44. In addition, panel 54′ may have an outer peripheral shape complementary to the shape of friction pad 44 to facilitate better placement of the sleeve 50′ on the base 18 and aligned so that the opening 55′ in the panel 54′ matches up or registers with the seat portion 34. In this embodiment, the panel 54′ may conform in size and shape to the size and peripheral shape of the friction pad 44.

Sleeve 50, 50′ may be formed from a fabric or a rubber or other material with stretch or resiliency to provide a comfortable fit around a user's thumb, and to accommodate users with varying thumb widths. Stretchy or resilient materials may include: stretch fabrics, such as fabrics comprised of or incorporating elastomeric fibers or elastomeric yarns including spandex, rubber sheets, fleece, Velcro® hook and loop fastener tapes, and polyurethane foams. One particularly advantageous material for the sleeve 50 or 50′ is DRI-FIT® stretch comfort microfiber fabric with spandex available from Nike, Inc. and Under Armour fabrics such as HeatGear®, ColdGear® and AllSeasonGear®. Such fabrics provide sufficient expansion and stretch to accommodate varying thumb widths, but also provide breathability and comfort.

Optionally, friction material may be applied or adhered to the inner surface of the sleeve 50, 50′ to enhance gripping connection of the tap device when worn on a user's thumb or other finger. The friction material may comprise one or more patches or spots or applied ridges of padding material, such as rubber, foamed rubber, latex foam or polyurethane foam, polysiloxane or other suitable gripping material. One possible material is REVO by iSkin, which is a silicone or polysiloxane embedded with an antimicrobial agent.

The overlay pad or friction pad 44 may be formed of a material the same as or comparable to that used for the friction material, such as rubber, foamed rubber, latex foam or polyurethane foam, or silicone or polysiloxane, or other suitable gripping material. Optionally, such material may incorporate one or more antimicrobial agents. One possible material is REVO by iSkin, which is a silicone or polysiloxane embedded with an antimicrobial agent.

The thumb worn tap device 10 has a base 18 with a first surface and an opposite surface. The first surface may be curved to accommodate the contour of a user's thumb print. The base 18 defines at least one opening therethrough to receive the seat portion 34. The base 18 may be formed of a polymeric material such as synthetic polymers or ethylene methyl acrylate (EMA) copolymers, ethylene vinyl acetate (EVA) copolymers, acrylics, high density polyethylenes (HDPE), styrenics (IMPS), acrylonitrile-butadiene-styrene (ABS) copolymers, poly(methylmethacrylates) (IM-PMMA), alpha-polyolefins, polypropylene, polycarbonate, polycaprolactam, polycaprolactone, polyacrylates, polyurethanes, polyesters, and mixtures thereof. The base should be of a substantially rigid material that is sufficiently rigid to permit touch screen operation with undue bending of the base, the collar or the nib.

In the embodiment of the tap device 10 shown in FIG. 1, the collar or post cover 36 has a length between about 2 to 5 mm and a diameter or width of about 1 to 5 mm. The base 18 has a length of about 15 to 35 mm, a width of about 5 to 20 mm, and a thickness of about 1 to 3 mm. The nib 24 may have a rounded or dome-shaped tip as shown in FIGS. 1 and 12-17. Alternatively, the nib may have a flatter tip (not shown). Referring to FIG. 1, the nib diameter is from about 1 to 5 mm, and the nib length is about 1 to 2 mm, with the tip portion having a length of up to about 1 mm. The sleeve 50 in the embodiment of the tap device 10 shown in FIG. 1 has an inner diameter in the range of about 5 to 20 mm. The length of the sleeve may vary, but generally may extend from the rear portion of the base to above the seat portion. Alternative sizing may be appropriate to adapt the tap device for use by persons with smaller or larger thumb or finger widths or to adapt to an alternate sleeve fabric choice with greater or lesser stretch or resiliency.

FIG. 17 shows a bottom plan view of the tap device 10. A hole or indentation 47 may be formed through or in the second surface 22 of the base 18 to serve as a snap fit mating portion or to house a female button 40 in an embodiment in which the tap device 10 may be stored on a storage clip. Also shown in FIG. 17 is a second friction pad 45. Second friction pad 45 defines a slot or hole therethrough at the centered rear portion of the second friction pad 45 such that a female button or female mating connector 40 may be exposed for connection to a storage clip.

The tap devices 10, 10′ according to the invention may be positioned so as to be worn around a user's thumb above the first knuckle. This positioning, along with the substantially stretchy material forming the sleeve 50, 50′, permits the user to bend his or her thumb naturally while he or she wears the tap device 10, 10′ and uses it to input data into a handheld electronic device. Such natural movement of the thumbs is a great advantage when inputting data using both thumbs (i.e., opposable thumbs), as is the preferred method of use for handheld electronic devices with a Querty keyboard or a touch screen keyboard. Moreover, as more and more handheld devices incorporate capacitive touch screens for user interface, some users with long fingernails or wide thumbs and fingers will have greater difficulty accurately inputting data into these handheld devices. The tap devices 10, 10′ according to this invention will facilitate more accurate, rapid and effective data entry by all users.

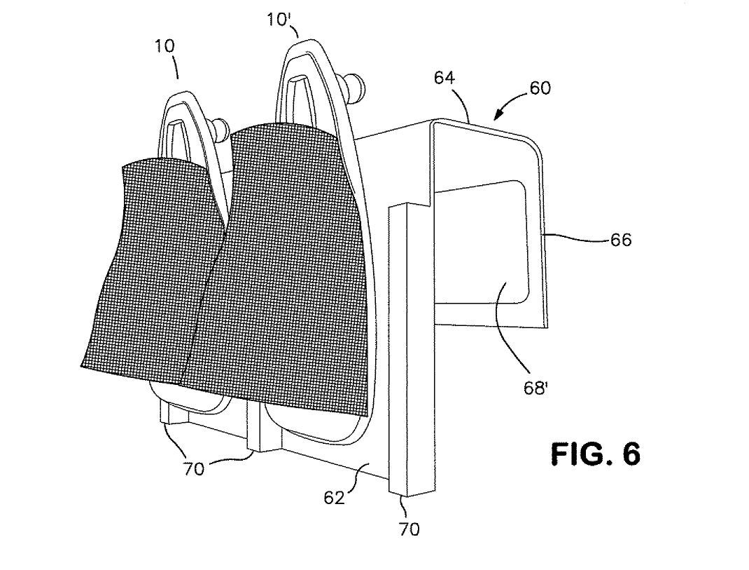

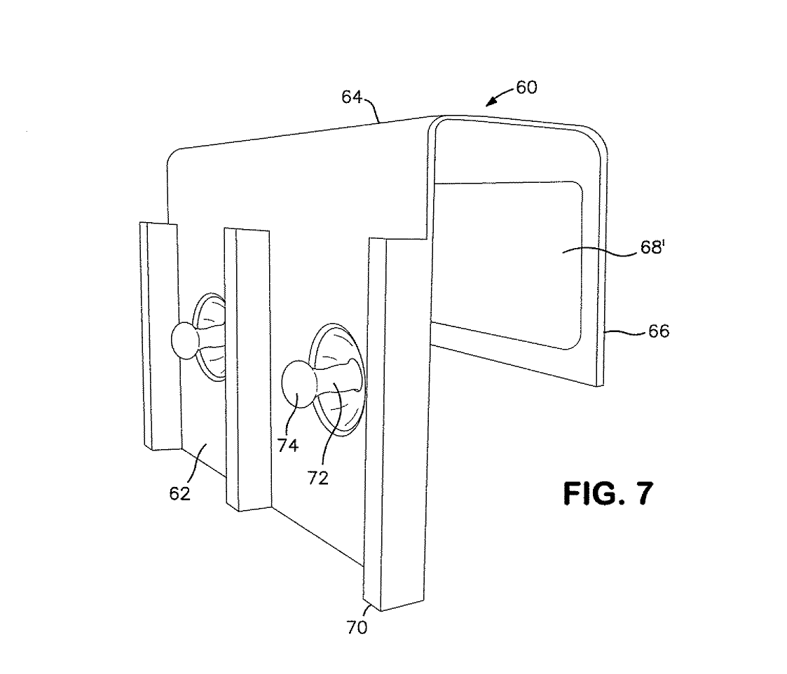

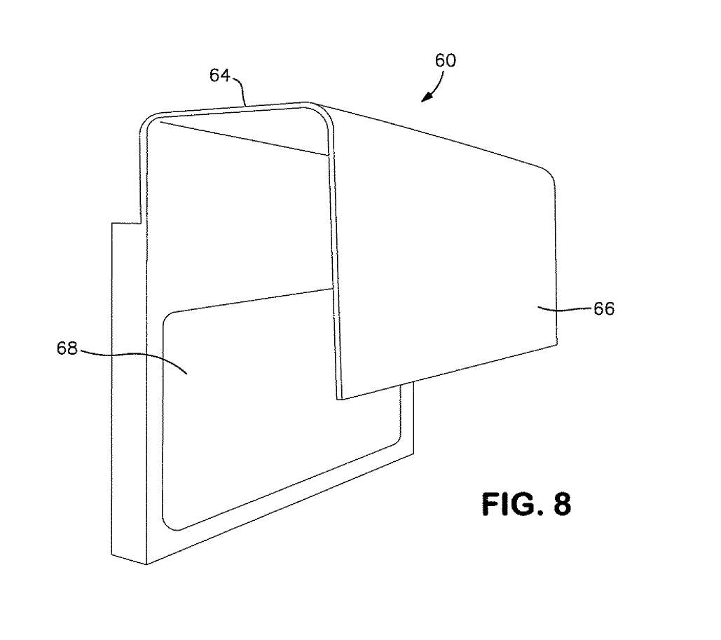

Referring next to FIGS. 6 to 9, a storage clip or holder 60 has a first vertical wall 62 and a second vertical wall 66 that are joined together by a bridging portion 64. The first and second vertical walls 62, 64, and bridge portion 64 together form an inverted “J-shape”. The second vertical wall 66 is approximately one-third of the width of the first vertical wall 62. Vertical separators 70 extend outwardly and generally perpendicularly from the outer wall of the first vertical wall 62 to demarcate two tap device holding zones. Projections or prongs or male buttons 72 with rounded outer tips 74 extend outwardly from the outer surface of the first vertical wall 62. Each of these projections or prongs or male buttons 72, 74 forms a mating connector that may be joined to the receiving hole 40 of a thumb worn tap device 10. As shown in FIG. 6, two tap devices 10, 10′ are connected to the projections or prongs or male buttons 72, 74 of the storage clip 60. The projections or prongs or male buttons 72, 74 may be integrally formed in the first vertical wall 62 or may be separate elements that are engaged to such wall with an adhesive.

Optionally, a friction pad 68 may be provided on the inner surface of the first vertical wall 62, and a friction pad 68′ may be provided on the inner surface of the second vertical wall 66. Such friction pads 68, 68′ may comprise padding material, such as rubber, foamed rubber, latex foam or polyurethane foam, polysiloxane or other suitable gripping material. One possible material is REVO by iSkin, which is a silicone or polysiloxane embedded with an antimicrobial agent. The friction pads 68, 68′ improve the engagement of the storage clip 60 over a handheld electronic device or another substrate to which a user has secured the storage clip 60. Preferably, the friction pads 68, 68′ are positioned at least on the bottom half of the inner surfaces of the first and second vertical walls 62, 66. Preferably, the friction pads 68, 68′ are made of the same material used to make friction pads 44, 45.

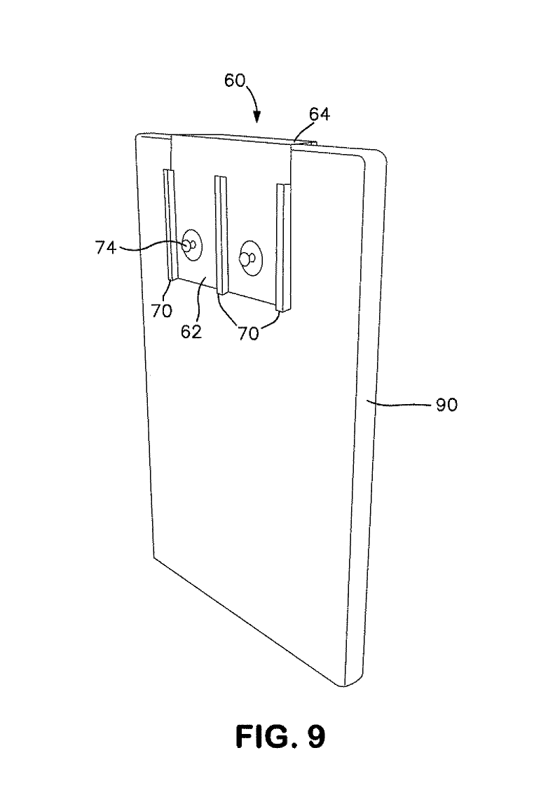

FIG. 9 shows the storage clip 60 engaged to an iPhone® handheld device 90. The clip 60 is positioned over the device 90 with friction pads 68, 68′ in contact with outer surfaces of the device 90. Alternatively, the clip 60 could be engaged to any clip-receiving surface, such as, but not limited to, a flap of a purse or backpack or portfolio cover or briefcase or notebook, etc.

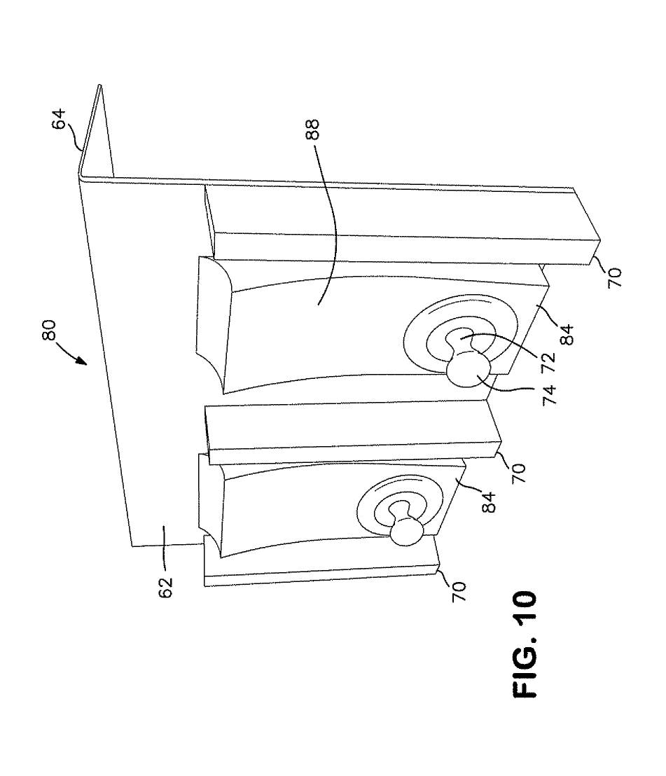

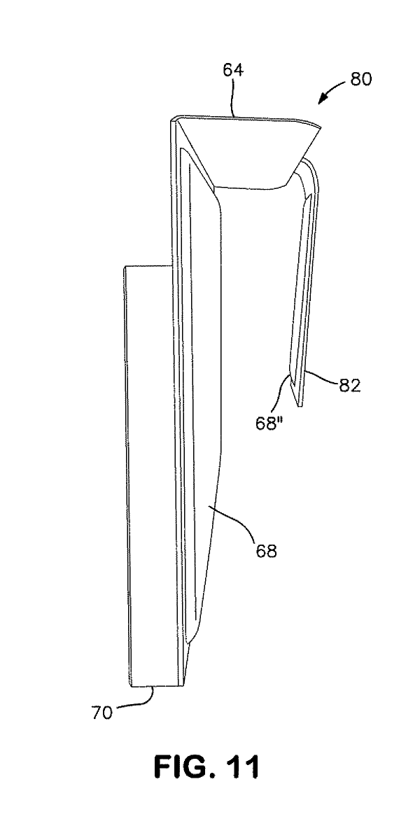

FIGS. 10 and 11 show an alternate embodiment of a storage clip or holder 80 that has a second vertical wall 82 of a width that may be the same as or different from the width of the first vertical wall 62. The storage clip 80 also has raised shelf or step portions 84 from which the projections or prongs or male buttons 72, 74 extend. The raised shelf portions 84 permit the tap devices 10, 10′ to be engaged to the projections or prongs or male buttons 72, 74 with the nibs resting on or over the first vertical wall 62. The nibs 24 may also be held spaced apart between the raised shelf or step portions 84 and the first vertical wall 62. Preferably, the raised shelf or step portions have front surfaces 88 that are concavely curved to facilitate seating the opposite surfaces 22 of the base portions 18 of each tap device 10, 10′ in contact with such front surfaces.

The storage clip or holder 60, 80 may be formed of a substantially rigid material, such as polymers, including ethylene methyl acrylate (EMA) copolymers, ethylene vinyl acetate (EVA) copolymers, acrylics, high density polyethylenes (HDPE), styrenics (IMPS), acrylonitrile-butadiene-styrene (ABS) copolymers, poly(methylmethacrylates) (IM-PMMA), alpha-polyolefins, polypropylene, polycarbonate, polycaprolactam, polycaprolactone, polyacrylates, polyurethanes, polyesters, or mixtures thereof, and such as metals. The selected substantially rigid material has strength necessary to create sufficient clamping force to hold clip in place, yet sufficient flex and bending resiliency to permit easy removal without cracking or breaking after multiple bending cycles. The holder may be integrally molded of one material, or elements may be separately formed and joined together.

While the tap device 10 is illustrated primarily for wear on a user's thumb, it is possible that some users will prefer to wear the tap device 10 on a different finger. Such alternative use is within the scope of this disclosure.

The invention has been illustrated by detailed description and examples of particular embodiments. Various changes in form and detail may be made to the illustrative embodiments without departing from the spirit and scope of the present invention. Therefore, the invention must be measured by the claims and not by the description of the examples or the particular embodiments.

1. A tap device, comprising:
a base having a first surface and an opposite surface and defining at least one opening therethrough;
a nib having at least a tip portion;
a post with a distal end in electrically communicative contact with the tip portion of the nib, and a proximal end in contact with a seat portion, wherein the post extends through the opening in the base and the seat portion contacts the first surface of the base;
a sleeve operably connected to the base so that a user's thumb may be inserted therein so as to place a portion of the user's thumb in contact with at least a part of the seat portion, wherein the first surface of the base faces the user's thumb and the opposite surface of the base is directed away from the user's thumb and the nib projects outwardly and away from the opposite surface of the base.

2. The tap device of claim 1, further comprising an overlay pad placed in contact with the first surface of the base.

3. The tap device of claim 2, wherein the overlay pad defines an opening through which at least a portion of the seat portion associated with the post is exposed.

4. The tap device of claim 1, wherein the second surface of the base defines a second opening therethrough or indentation therein forming a mating connection with a snap or projection or prong or male button of a holder to which the tap device may be secured for storage.

5. The tap device of claim 1, further comprising an overlay pad placed in contact with the second surface of the base.

6. The tap device of claim 5, wherein the overlay pad defines an opening through which a female mating connector defined in the second surface of the base is exposed.

7. The tap device of claim 1, wherein the sleeve is formed of a material selected from the group consisting of: stretch fabrics, such as fabrics comprised of or incorporating elastomeric fibers and yarns including spandex, polyurethane or rubber, fleece, polyurethane foam and hook and loop fastener tapes, DRI-FIT® stretch comfort microfiber fabric, and HeatGear®, ColdGear®, and AllSeasonGear® fabrics.

8. The tap device of claim 1, further comprising friction material applied or adhered to an inner surface of the sleeve.

9. The tap device of claim 1, wherein the post is threadably connected to the nib.

10. The tap device of claim 1, wherein the base is formed from a material selected from the group consisting of: ethylene methyl acrylate (EMA) copolymers, ethylene vinyl acetate (EVA) copolymers, acrylics, high density polyethylenes (HDPE), styrenics (IMPS), acrylonitrile-butadiene-styrene (ABS) copolymers, poly(methylmethacrylates) (IM-PMMA), alpha-polyolefins, polypropylene, polycarbonate, polycaprolactam, polycaprolactone, polyacrylates, polyurethanes, polyesters, and mixtures thereof.

11. The tap device of claim 1, wherein the sleeve is joined to the base with one or more adhesives.

12. The tap device of claim 1, wherein the sleeve includes a panel having lesser stretch and such panel is joined to the base with one or more adhesives.

13. The tap device of claim 1, wherein the nib defines a central axis and the central axis is directed at an angle in the range of about 30 degrees to about 150 degrees from a longitudinal axis defined by a user's thumb when the tap device is worn on said thumb.

14. The tap device of claim 1, wherein the nib defines a central axis and the central axis is directed at an angle in the range of about 30 degrees to about 150 degrees from a dominant plane of the opposite surface of the base.

15. The tap device of claim 1, wherein the nib has a curved outer surface.

16. A storage clip for one or more tap devices, comprising:
a first vertical wall separated from a second vertical wall by a bridging portion, wherein the first vertical wall, second vertical wall and bridging portion together form an inverted J-configuration or triangular configuration when viewed in side elevation;
at least one projection or prong or male button projecting outwardly from an outer surface of the first vertical wall, wherein said at least one prong mates with a receiving hole formed in a base of the tap device.

17. The storage clip for one or more tap devices of claim 16, further comprising a second prong projecting outwardly from the outer surface of the first vertical wall, wherein said second prong mates with a receiving hole formed in a base of an additional tap device.

18. The storage clip for one or more tap devices of claim 16, further comprising a friction pad disposed on an inner surface of the first vertical wall.

19. The storage clip for one or more tap devices of claim 16, further comprising a friction pad disposed on an inner surface of the second vertical wall.

20. The storage clip for one or more tap devices of claim 16, wherein the clip is formed from a material selected from the group consisting of: ethylene methyl acrylate (EMA) copolymers, ethylene vinyl acetate (EVA) copolymers, acrylics, high density polyethylenes (HDPE), styrenics (IMPS), acrylonitrile-butadiene-styrene (ABS) copolymers, poly(methylmethacrylates) (IM-PMMA), alpha-polyolefins, polypropylene, polycarbonate, polycaprolactam, polycaprolactone, polyacrylates, polyurethanes, polyesters, or mixtures thereof, and a metal.

21. The storage clip for one or more tap devices of claim 16, wherein the friction pad is formed from a material selected from the group consisting of: rubber, foamed rubber, silicon, polysiloxane, polyurethane foams or films, and polyurethane elastomers.
